(19) United States
(12) Patent Application Publication
(10) Pub. No.: US 2007/0261006 A1
(43) Pub. Date: Nov. 8, 2007

(54) METHOD AND DEVICE FOR PROVIDING A SELECTION MENU ALLOCATED TO A DISPLAYED SYMBOL

(75) Inventors: Christian Reissmueller, Sulzberg (DE); Frank Schueler, Karlsruhe (DE)

Correspondence Address: DARBY & DARBY P.C., P.O. BOX 770, Church Street Station, New York, NY, 10008-0770, US

(73) Assignee: ComBOTS Product GmbH, Karlsruhe (DE)

(21) Appl. No.: 11/745,575

(22) Filed: May 8, 2007

(30) Foreign Application Priority Data
May 8, 2006 (DE) 10 2006 021 399.8

(51) Int. Cl. G06F 3/048

(52) U.S. Cl. 715/837; 715/810

(57) ABSTRACT

A method and device which provides a selection menu allocated to a displayed symbol is provided. A graphic display unit has a display interface and an input device that controls a pointer on the display interface. A control unit drives the display unit such that upon activation of a predefined function, selection elements are represented on the display interface so that an image form of the displayed symbol can be selected using the selection elements. The control unit also drives the display unit such that when the pointer of the input device is positioned over one of the selection elements, the selection element is animated.

This application claims priority to German Patent Application No. DE 10 2006 021 399.8, filed May 8, 2006, the contents of which is hereby incorporated by reference as if set forth in its entirety.

The invention relates to a method and a device for providing a selection menu allocated to a displayed symbol.

### BACKGROUND

In known traditional communication systems, users already connected to a terminal are displayed as a symbol on a display interface of the terminal. This symbol can be, for example, an icon or also an image or photo. By activating operating elements allocated to the symbol, a communication connection to the allocated communication partner can be constructed, often in the form of an Instant Messaging or IM communication connection or also in the form of a file-swapping, video or voice communication. In traditional communication systems, the symbol displayed to the communication partner is animated without the animation being able to be matched to the mood of the allocated communication partner. Communication partners on the Internet convey their mood by sending their own smiley symbols provided for this purpose, by so-called emoticons. This makes possible a simple non-verbal communication, where various such symbols or emoticons are available for selection.

### SUMMARY

An embodiment of the present invention provides a method and device which provide a selection menu allocated to a displayed symbol. A graphic display unit has a display interface and an input device that controls a pointer on the display interface. A control unit drives the display unit such that upon activation of a predefined function, selection elements are represented on the display interface so that an image form of the displayed symbol can be selected using the selection elements. The control unit also drives the display unit such that when the pointer of the input device is positioned over one of the selection elements, the selection element is animated.

### BRIEF DESCRIPTION OF THE DRAWINGS

Exemplary embodiments of the present invention are explained in more detail below with reference to the accompanying drawings, in which:

FIG. 1 illustrates a schematic view of a communication system with two terminals according to the present invention; and

FIG. 2 to FIGS. 16a-d illustrate various representations of graphic displays of selection menus on a graphic user interface according to the present invention.

### DETAILED DESCRIPTION

In an embodiment of the present invention, a method and device is provided for a non-verbal form of communication in which the animation of the symbol displayed to the communication partner can be chosen easily.

According to an embodiment of the present invention, a device for preparing a selection menu allocated to a displayed symbol is provided. The device includes a graphic display unit which has a display interface, an input device with which a pointer on the display can be controlled on the display interface, and a control unit which drives the display unit, with the result that when a predefined function is activated, selection elements are displayed on a display interface of the display unit. In particular, the selection elements are displayed in the selection menu, where an image form of the displayed symbol can be selected via the selection elements, and the control unit drives the display unit such that when the pointer of the input device is positioned over one of the selection elements the corresponding selection element is animated.

The control unit can preferably drive the display unit such that when the pointer of the input device is positioned over one of the selection elements, the corresponding selection element is highlighted by being displayed as enlarged on the display interface or in the selection menu, displaced on the display interface, or displayed in a different color. Furthermore the selection elements can be arranged in a grid.

The control unit can drive the display unit such that the selection menu is displayed with a size-adjustment element in order to set the size of the displayed selection elements and/or of the grid or of the measurements of the grid.

The control unit can preferably drive the display unit such that the selection elements are displayed with a text-display selection element in order to switch on or off the display of a text to at least one of the selection elements.

Furthermore, the selection elements can be displayed with several header elements by activating one of the header elements to make a choice from the selection elements displayed in the selection menu. In particular, the choice is selected according to predefinable criteria, such as predefinable categories, collections, and/or groups of selection elements.

In particular, the selection elements can be allocated to the currently displayed symbol. The selection elements can provide an animation which is provided in conjunction with the symbol displayed.

According to an embodiment of the invention, the selection elements correspond to alternative symbols to the currently displayed symbol. Furthermore, the control unit can be designed such that when one of the selection elements is chosen, the control unit informs a further device connected to the device of the selection.

According to an embodiment of the present invention, a method is provided for preparing a selection menu allocated to a displayed symbol. The method includes displaying a selection menu with selection elements on a display interface of a display unit upon activation of a predefined function. An image form of the displayed symbol can be selected via the selection elements; and animation of a corresponding selection element when a pointer of an input device is positioned over the selection element.

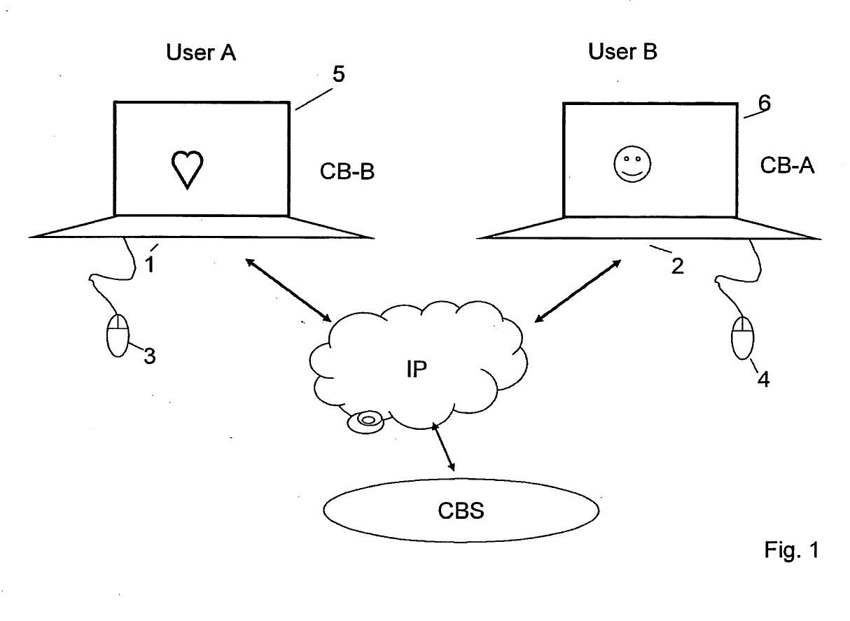

FIG. 1 shows a schematic view of a communication system in which two communication partners, user A and user B, can exchange data via a network, such as the Internet IP, in order to communicate with each other in various ways. It is noted that instead of using the Internet IP, other networks can also be used. The network nodes in the networks, and also the end-points at the users (end-nodes) form a decentralized organized network such as the communication system. The transmission of data for the communication can occur via the various nodes which have essentially equal access and, depending on data flow, perform the function of a send, destination or transmission node. The control device CBS essentially manages the decentralized organization of the communication system. In particular, the control device controls access to the communication system by verifying the user authorization or authentication. The communication system integrates or connects transmission methods from store-and-forward or peer-to-peer and all possible types of communication. Possible types of communication include voice telephony, e-mail, IM (instant messaging), exchange of data of all types and also the operation of file-sharing applications, whiteboard applications and others.

For communication, each user has at his disposal a corresponding terminal 1, 2 which are shown here as PCs (personal computers). Other terminals 1, 2, such as mobile telephones, PDAs (personal digital systems) and similar with which a user can construct a data connection to the network IP in order to communicate via it, come into consideration as terminals 1, 2. The terminals 1, 2 can be connected to suitable input and output devices ideally having a telephone headset, a mouse 3, 4, a keyboard and a screen 5, 6. The communication system has at its disposal the central control device CBS which controls, monitors, supports and/or organizes the communication between the terminals of users A and B. To this end, the central control device CBS has at its disposal suitable software which can control access to the system and control the basic mechanisms of the connection set-up between terminal 1 and terminal 2 of the corresponding users A and B.

One feature of the communication system of the present invention is the graphic communication element, herein referred to as ComBOTs™ below, which is shown schematically in FIG. 1 and provided with the reference items CB-B and CB-A. ComBOT™ and ComBOTs™ are a trademark of ComBOTS Product GmbH. A ComBOT™ is essentially an operable and animatable element (e.g., icon, symbol, figure, etc.) on the screen of terminal 1, 2 of the respective communication partner (e.g., user A) which allows contact to the other communication partner (user B). For example, on the screen of terminal 1 of user A there is a ComBOT™ (CB-B) which represents the other user B. Conversely, there is a ComBOT™ (CB-A) on the screen of terminal 2 of user B. The look and appearance of the ComBOT™ can be determined by each user, preferably the user who is represented by the respective ComBOT™. In the example shown here, user A is represented by a smiley and user B by a heart.

In terminals 1, 2, application software, such as client software, is run and connects to the central control unit CDB in particular to a server installed there. The client software carries out an authentication of the respective user A, B in the communication system. The user also performs certain functions via the ComBOTs™ and specifies parameters for the user that can preferably be stored in user profiles inside the central control device. Furthermore, signalling data are exchanged with the help of the client software which runs on the respective terminal 1, 2. This allows the central control device to control or at least prompt the construction of various transmission paths within the network for the transmission of the useful data required for communication.

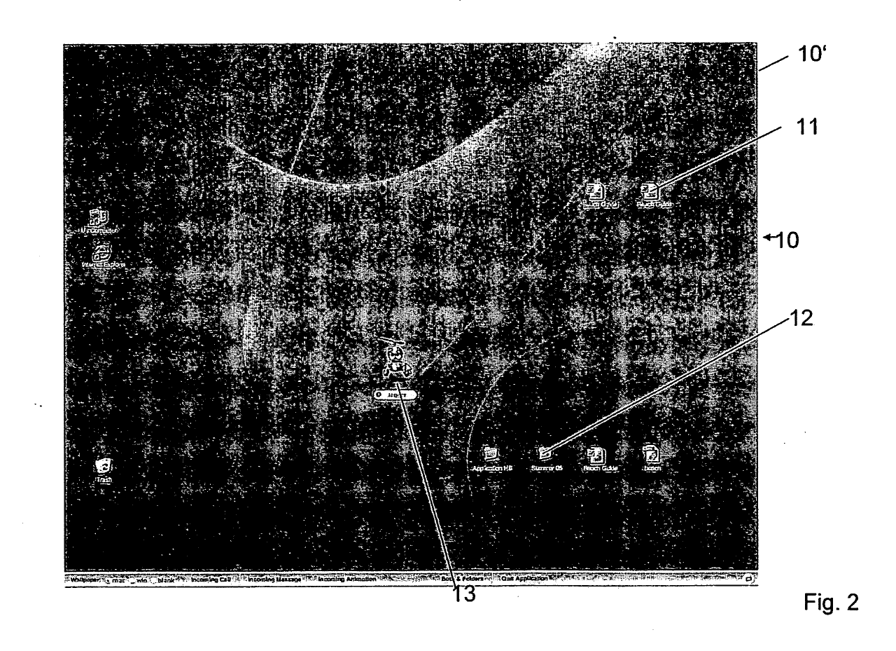

The running of the client software via an interaction with the ComBOT™ CB-B, CB-A, on the screen of the respective terminal is described in more detail below. To this end, the user's possibilities for interaction with a ComBOT™ displayed on his screen, which represents a further user as communication partner, are shown in FIGS. 2-14.

FIG. 2 shows a display interface 10′ in the form of a user interface or desktop of a conventional operating system in which symbols for files 11 and folders 12 are arranged on a background surface 10, i.e., a surface of the screen display which is not shown in a window. By double-clicking on the respective symbol 11, a user can open the file, executing it if an executable program file is involved or with a linked application if the file is a content file, such as a text file. By double-clicking on a symbol 12 which represents a folder, a folder window is opened in which symbols for several files located therein, or further folders, are displayed which the corresponding user can execute or process in the manner described above.

Also located on the background surface 10 or the display interface 10′ (desktop) shown in FIG. 2 is a ComBOT™ 13 which, in the shown embodiment example, is a figure with a propeller hat, called “propeller man” below. The propeller man is a ComBOT™ 13 for a second user, e.g., user B, connected to terminal 1, 2 of the user, e.g., A, with whom there is a communication connection. Displayed below the propeller man is a label with the name “Jagger”, which can display the name of communication partner B represented by the propeller man. The propeller man including the label optionally to be provided is thus the ComBOT™ 13 which represents the communication partner B “Jagger”.

The propeller man is preferably animated and performs a circular movement according to a first animation sequence, with the result that it serves to catch the eye of the user A, B on the background image. The animation of the ComBOT™ 13 can essentially be selected preferably by the communication partner to whom it corresponds, depending on the situation, and a static ComBOT™ 13 can also be selected depending on the currently available computing and/or storage capacity.

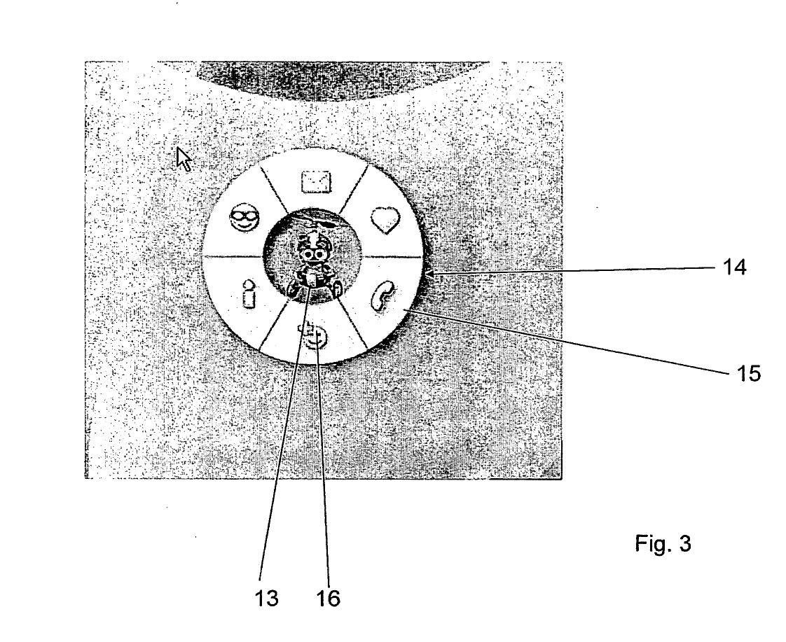

In an embodiment of the present invention, functions that are executed by the client program which is allocated to ComBOT™ 13 can be activated in various ways. To gain access to these functions, a particular user menu 14, here called ComBOT™ menu, is opened by a suitable activation such as a left or right mouse click, controlled by the corresponding computer mouse 3, 4, on the ComBOT™ 13 (or on a symbol allocated to same), which allows a selection of various functions of the client program. An example of such a ComBOT™ menu 14 is shown in FIG. 3. The ComBOT™ menu 14 can also be opened by a mouse movement such as a mouseover which is executed via the relevant ComBOT™ 13 or in another spatial relationship to the position of ComBOT™ 13 on the display interface of the screen. Thus, for example, with the help of a circular movement when there are several ComBOTs™ located on the background image preferably around the ComBOT™ 13 to be selected, a ComBOT™ 13 can be selected and the ComBOT™ menu 14 activated for a subsequent selection of a desired function, with the result that the ComBOT™ menu 14 is displayed on the background surface 10 of the screen.

The ComBOT™ menu 14 is preferably displayed enclosing the ComBOT™ 13 and has segments 15 which have selection elements 16. The ComBOT™ menu 14 is thus not only functional for the respective ComBOT™ 13, but also graphically directly allocated thereto. The selection elements 16 can be activated by clicking or by other actions. The ComBOT™ menu 14 enclosing ComBOT™ 13 can be ring-shaped, elliptical or also otherwise enclosing the ComBOT™ 13, with the result that the ComBOT™ 13 remains visible in the middle of the ComBOT™ menu 14 and the individual segments 15 with the selection elements 16 arranged therein in a group around the ComBOT™ 13. The ring-shaped ComBOT™ menu 14 has the advantage that a direct allocation of the menu to the corresponding ComBOT™ 13 is possible, with the result that, in particular when there is a larger number of different ComBOTs™ 13 which represent different communication partners, the ComBOT™ menu 14 clearly represents one of the communication partners. Namely, the communication partner who corresponds to the ComBOT™ 13 displayed inside the ring-shaped ComBOT™ menu 14, in this case the propeller man, is clearly represented. In this manner, it is possible to have a clear allocation of the ComBOT™ menu 14 to the corresponding ComBOT™ 13 when several ComBOT™ menus 14 are open.

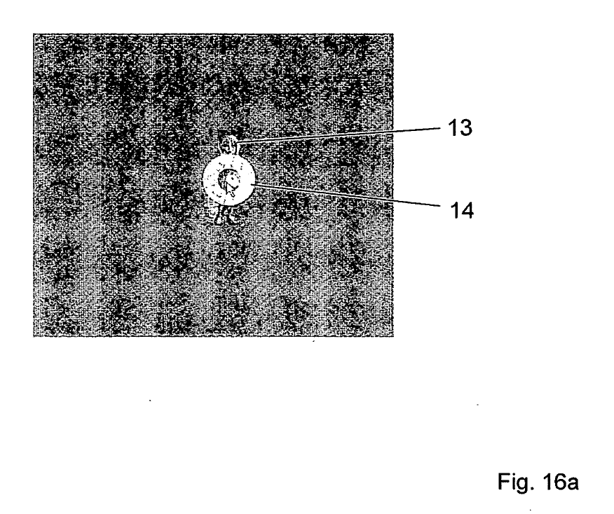

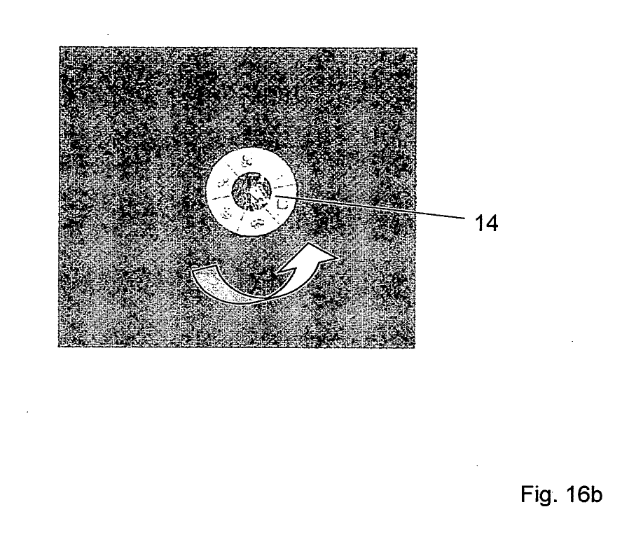

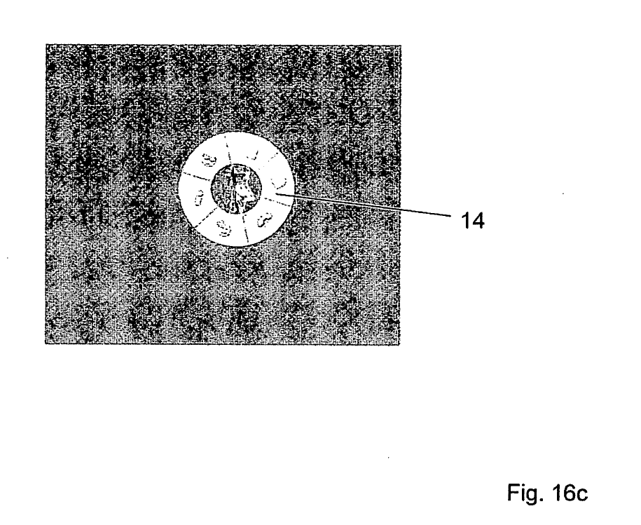

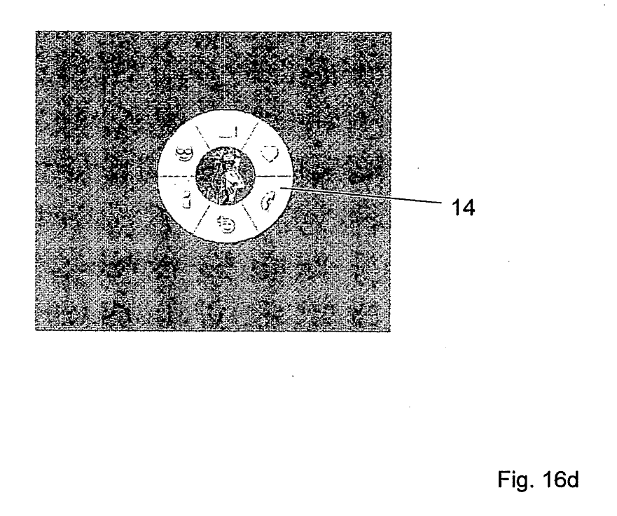

The ComBOT™ menu 14 can appear by activating the ComBOT™ 13 in a manner as described above (e.g., clicking, mouse movement, keyboard shortcut, etc.) such that the ComBOT™ spirals outwards. The ring-shaped ComBOT™ menu 14 enlarges starting from the ComBOT™ 13 until it has reached its definitive size, and turns while doing so, with the result that the arrangement of the individual segments 15 and the selection elements 16 contained therein correspond to a predefined arrangement. This feature is also illustrated in FIGS. 16 a to 16b, which show, by way of example in individual images, the progress or the sequence of a ComBOT™ menu 14 opening spirally around a ComBOT™ 13.

The ComBOT™ menu 14 can be deactivated when another function is executed on the background surface of the terminal, or when the ComBOT™ menu 14 of a ComBOT™ 13 representing a further communication partner is activated. The ComBOT™ menu 14 can also be deactivated by clicking, for example, on an empty part of the background surface 10. When the ComBOT™ menu 14 is deactivated, the ComBOT™ menu 14 preferably disappears in a manner similar to that in which it appeared, namely by spiralling in again, such as by turning and simultaneously shrinking until it disappears at the location of the ComBOT™ 13. When the ComBOT™ menu 14 is activated, the ComBOT™ 13 can execute a second animation sequence as further eye catcher which differs from the first animation sequence when the ComBOT™ menu 14 is deactivated.

The segments 15 of the ComBOT™ menu 14 are preferably ring segments in the shown embodiment example which completely enclose the ComBOT™ 13. Depending on the number of functions provided for the client program, the ring segments 15 can be enlarged and reduced, and the ComBOT™ menu 14 can also comprise several rings with respective segments 15 which are arranged concentrically beside each other around the corresponding ComBOT™ 13.

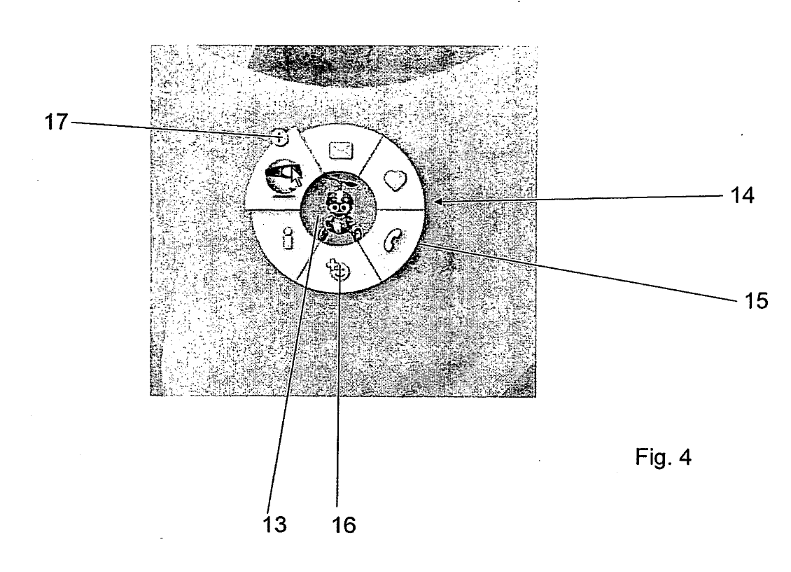

As shown in FIG. 4, as soon as the mouse pointer is moved over a segment 15 of the ring-shaped ComBOT™ menu 14, the respective segment 15 stands out. In the example, it is displayed enlarged and/or can be arranged offset vis-a-vis the original position of the segment 15. Furthermore, the colors of the selection element 16 displayed in the segment 15 can change, with the result that it is easily recognizable that a function allocated to the selection element 16 can be activated by clicking or other actions. The selection element 16 can be static or animated, in order to direct the attention of the user to the segment 15 of the ComBOT™ menu 14 that has been selected in this way.

When one of the segments 15 of the ComBOT™ menu 14 is highlighted, the segment 15 can also be provided with an information selection element 17 which, in this example, is circular and is located on an outer edge of the respective segment and contains a symbol “i”, which represents help menus or information. If the mouse pointer now moves from the activated segment to the information selection element 17 according to a mouseover function or other action, either a textbox can immediately appear which contains help information, or a further menu with selectable functions can be activated, or a help film sequence can be displayed to explain the selection element 16 to which the information selection element 17 belongs.

Both the activation of a segment of the ComBOT™ menu 14 and the activation of the information selection element 17 can be “commented” with a changed animation of the ComBOT™ 13 displayed inside the ring-shaped ComBOT™ menu 14. In particular, upon activation of the information selection element 17, the animation of the ComBOT™ 13 can back up or supplement the explanation of the function of the segment 15 of the ComBOT™ menu 14 that is allocated to the information selection element 17.

In an embodiment according to the present invention, a selection element 16 of the ComBOT™ menu 14 makes available, for example, a telephone function which is displayed as a telephone receiver symbol in a corresponding segment 15 of the ComBOT™ menu 14. If the mouse pointer is moved to the telephone receiver symbol and then to the information symbol “i”, the animation of the ComBOT™ 13 inside the ring-shaped ComBOT™ menu 14 can change and the latter displays, for example, dialling a telephone and holding a receiver to his head, with the result that a user is shown the function of the segment 15 of the ComBOT™ menu 14 as an animation. Thus, foreign-language users can also be helped via the information selection element 17.

In particular, the ring-shaped selection menu or ComBOT™ menu 14 allows for a permanent allocation of the ComBOT™ menu 14 to the respective ComBOT™ 13. This provides the benefit that irrespective of the number of selection elements or menu items 16 to be provided, a clear allocation to the communication partner represented by the ComBOT™ 13 can take place.

If a segment 15 of the ComBOT™ menu 14 is connected to further subfunctions, these subfunctions can be displayed as a ComBOT™ submenu, which can extend in a ring-shape as an additional ComBOT™ menu 14 or as a ring segment around the already displayed ComBOT™ menu 14, and can have further segments which are each linked to the specific subfunctions.

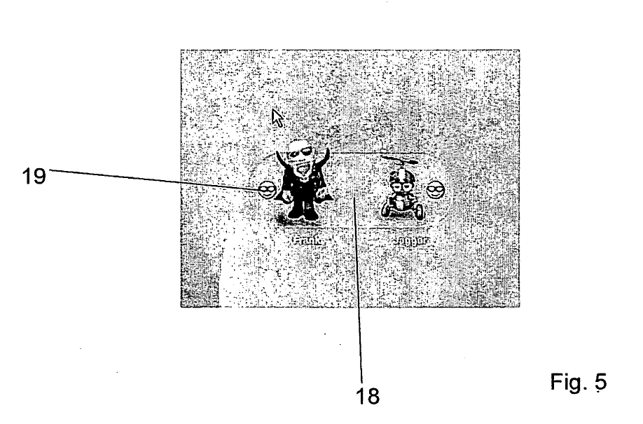

If the display in the embodiment is as displayed in FIG. 5, a so-called arena 18 opens in which both the ComBOT™ 13, which represents the user of the current terminal, in this case “Frank”, who is displayed as a ComBOT™ figure “Dracula”, and the ComBOT™ 13, which shows the communication partner “Jagger” (as propeller man) allocated to the activated ComBOT™ 13, are displayed. The two ComBOTs™ 13 are located inside a graphically delimited zone, called arena 18 below, which is displayed in a different color and/or by a suitable border around the two ComBOTs™ 13.

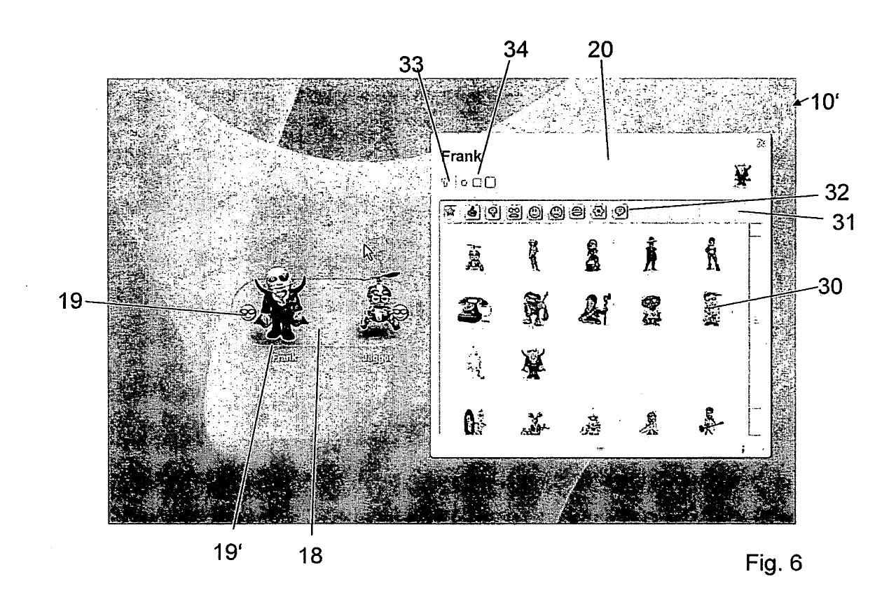

The respective ComBOT™ figure “Dracula” or “propeller man” displays a symbol in the form of a graphic figure whose appearance or image form can be changed. If the user wishes, for example, to change the ComBOT™ for “Frank”, i.e., “Dracula”'s symbol 19′, he can open a selection menu provided to this end, in which different image forms and/or alternative symbols, such as “man with hat” or “ghost” or “telephone” are offered to the user for selection. This features is illustrated in FIG. 6.

Beside each of “Frank”'s ComBOT™ 19′ and “Jagger”'s ComBOT™ (see reference item 13 in FIGS. 2-4), a smiley symbol 19 is displayed with which, as is shown in FIG. 6, another selection menu in the form of a grid can be opened by clicking, the image of the ComBOT™ 19′ allocated to the smiley being able to be changed in the arena 18. Depending on which ComBOT™ 13, 19′ smiley is activated, the image of the current user of the terminal or the image of the communication partner “Jagger” can be changed.

In an embodiment of the present invention, the selection menu 20 can display a number of different ComBOT™ image forms 30 which are predefined but can also partly be defined by the user. For example, there are figures such as “man with hat”, “monster”, “ghost”, etc. or also graphic symbols such as “telephone” or similar. The user can choose a new image form (also called characters) for his ComBOT™ or for that of his partner in order to represent himself or the partner. The selection menu 20 offers a large number of different image forms. These can be characters which are freely available.

Furthermore, ComBOT™ image forms 30 can also be displayed which are not freely available or immediately available for selection, but can be obtained from a provider or online shop of such ComBOT™ image forms. The offered image forms are thus selection elements already provided or offered to the user. The elements are displayed or arranged preferably in a grid, here in the form of a matrix, the size of which can be changed. This can be the size of the grid itself and/or the size of the individual elements, or the number of individual elements. The selection menu 20 or grid is thus employed by the user to pick out a new ComBOT™, and can also be referred to as a ComBOTs™ picker.

The selection elements, or ComBOTs™ image forms, displayed in the selection menu 20 or the grid can be allocated to different system. The elements can also be user-specified headers and thus, correspondingly displayed. The ComBOTs™ image forms are ordered or filtered according to specific selections. For this the selection menu 20 has at its disposal display filters which are activated via corresponding header switches or buttons or header elements 32.

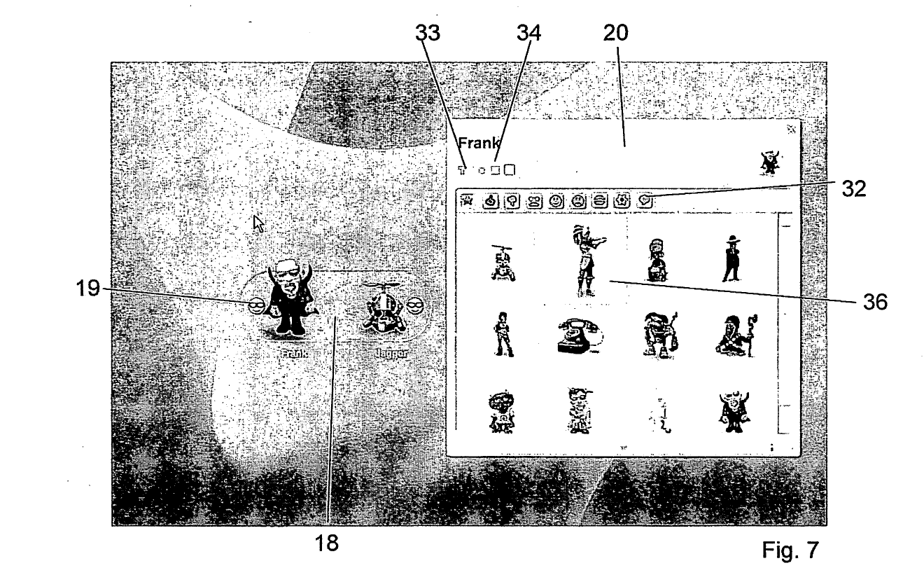

In a header area 31, the nature, such as the category or group, of the respective ComBOT™ image can firstly be selected via a suitable header element 32 and the respective ComBOT™ image form to be selected then selected by moving the mouse pointer over the ComBOT™ image forms displayed in a grid. Once the mouse pointer moves over the ComBOT™ image form, the latter is enlarged and highlighted (see FIG. 7, reference number 36), with the result that the user can review his choice before making his selection. It is furthermore provided that the ComBOT™ image 30 over which the mouse pointer is located is displayed with an animation.

For example, the user can firstly selects or preselects “monster”, by clicking on one of the buttons 32, and then searches for a monster from the monsters displayed, such as the figure “Frankenstein's monster” 30. The size of the grid, the measurements of the grid, the number of displayed ComBOTs™ and/or their manner of display with regard to size, color, animation, sound etc., can depend on the chosen selection or header. If, for example, the chosen selection or header is “monster”, the monster ComBOTs™ offered for selection are shown in a larger grid, where the monster ComBOTS these are also animated and sound or tone sequences are also played. If “office” is selected, only the corresponding symbols (telephone, writing desk, bookcase etc.) are displayed on a small grid scale and without animation and/or sound.

For better orientation, the selection elements 30 can be further provided with suitable descriptions in the form of text information, badges or labels, such as “Frankenstein”. A text-selection element 33 and one or more enlargement-adjustment elements 34 can also be provided. The text-selection element 33 serves to switch on or off the display of a text allocated to the ComBOT™ image, such as, for example, a name, a greeting or other information. The enlargement-adjustment elements 34 serve to adjust the size with which the ComBOT™ images 30 are displayed in the grid of the selection menu 20.

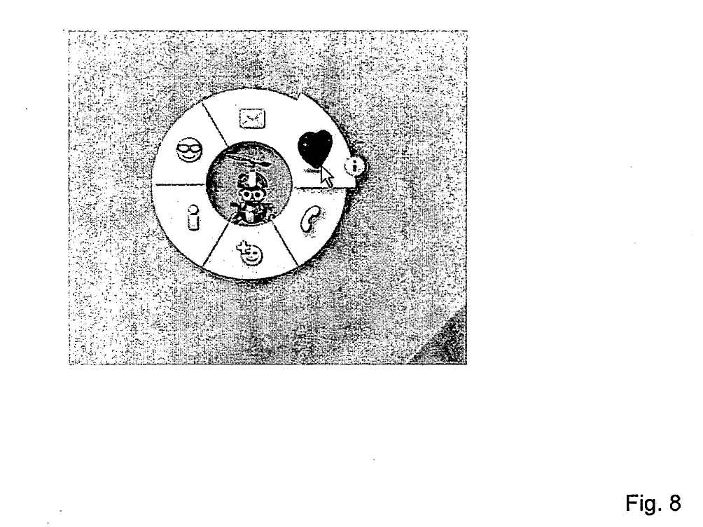

In an embodiment of the present invention, there is provided in the ComBOT™ menu 14 a further segment 15 which, in the shown example, is provided with a heart symbol (see FIG. 8) via which the connected communication partner can be sent a specific animation in order to establish a non-verbal communication. The communication partner, that of the relevant ComBOT™ 13 to which the ComBOT™ menu 14 is allocated, receives corresponding animation data which result in a specific animation of the ComBOT™ 13 allocated to the current user being executed on the background surface of the terminal of communication partner B. This means that user A's ComBOT™ 13 executes on the background surface of user B's terminal an animation which user A has selected in order to communicate non-verbally with user B.

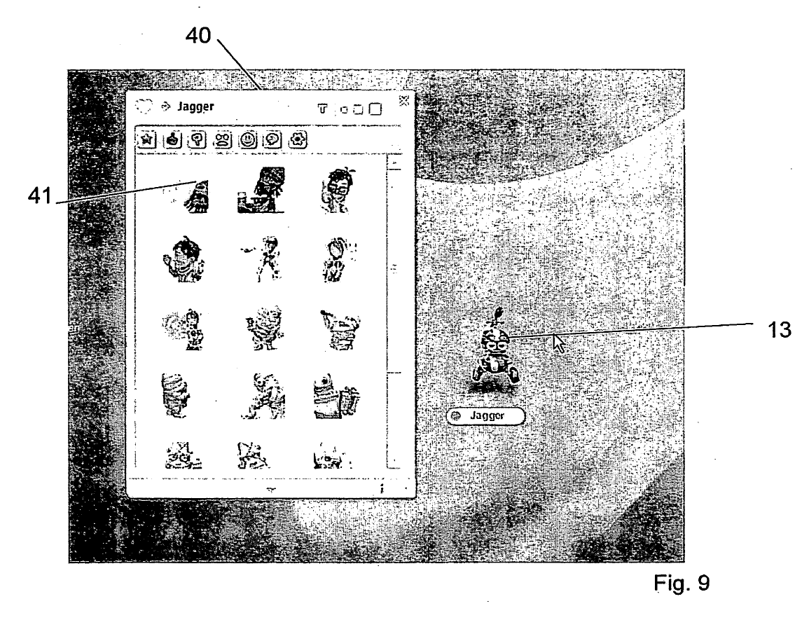

The animation can also be selected via a so-called “picker”, namely via an animation selection menu 40, which is shown by way of example in FIG. 9. The selection is carried out by displaying in one grid different animation symbols 41 which, when the mouse pointer moves over them in a mouseover function, are displayed enlarged and begin to execute the animation allocated to them. The animations can be divided into groups which can be selected through suitable header elements 42 in order to display animation symbols 41 for different emotions or information for the selection of the suitable animation. Possible animations are, for example, the handing over of a present, laughter, anger, etc., which are allocated to the ComBOT™ 13 which represents user A and which are sent to the selected communication partner B, with the result that the corresponding ComBOT™ 13 allocated to the current user selecting the animation executes the animation.

The structure of the animotion-selection menu 40 (here also called “animation picker”) is substantially similar to that of the selection menu 20 for the ComBOT™ images, wherein the animation is executed once the mouse pointer moves over one of the ComBOT™ images shown there. The provided animations can be generally valid, with the result that they can be executed regardless of the ComBOT™ image used by the current user, i.e., with any ComBOT™ image, or can also be carried out with only a few specific or only one ComBOT™ image 30.

The offered animotions can be displayed in the form of animated preview images or small preview films (previews) when the user moves over the corresponding symbol with his PC mouse. For example, in the case of a mouseover over the “peace” animation (symbol or element “41” in FIG. 9), the element is enlarged and a preview in the form of an “Indian smoking a peace pipe” is displayed therein. When the user clicks on this element, the complete animotion is started or incorporated into the communication for transmission to the partner.

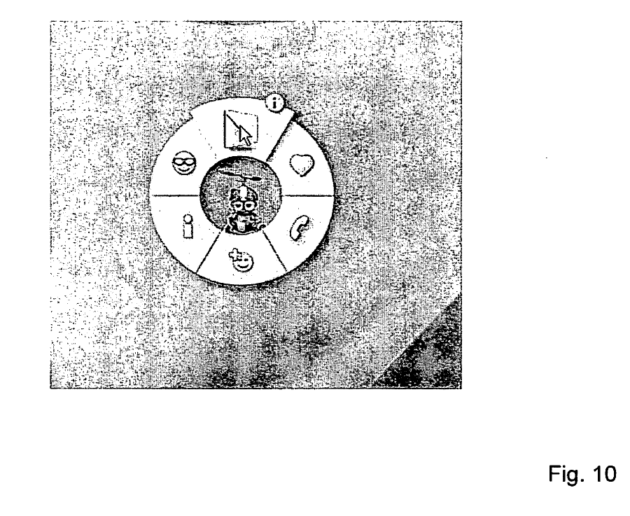

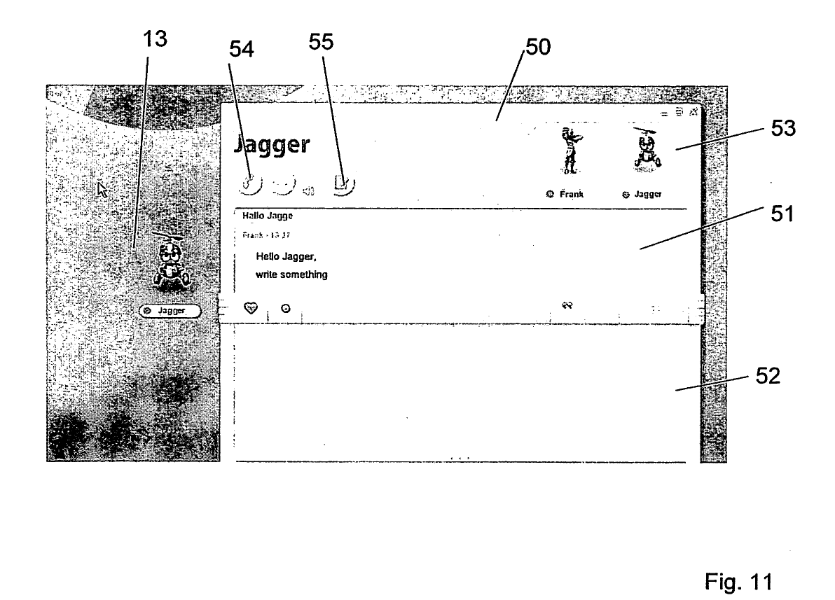

Upon selection of a segment 15 of the ComBOT™ menu 14 in which the selection element 16 is displayed as an envelope (see FIG. 10), a communication window 50 is opened with which the current user can communicate with the communication partner via, for example, an IM (Instant Messenger) connection. This is shown in FIG. 11. For this purpose, the communication window 50 is designed in two parts and shows in a first subwindow 51 the texts written by the current user and the communication partner. In a second subwindow 52, the current user can compose messages which he can send by pressing the “Enter” key, and which are then displayed in the first subwindow 51 of both the current user and the communication partner to whom the written text message is being transmitted.

The communication window 50 can furthermore have an area in which a history of the most recently conducted IM discussions is listed. The history is a listing of communication or conversation already conducted and includes all the events or sections of the previously conducted communication, i.e., exchange of messages, text, images, documents, etc. both in real time or virtual-real time and also time-shifted. The system of the present invention supports and integrates all types of communication, with the result that the customary distinctions between synchronous and asynchronous communication, such as e.g., Instant Messaging or e-mail, do not occur here. The users can communicate with each other at any time and by multimedia, without having to be concerned about the transmission method, online presence of the partner or similar.

Furthermore, both the ComBOT™ image of the current user and the ComBOT™ image of communication partner B can be displayed in one arena area 53 of the communication window. The current user A can select a suitable ComBOT™ image for every possible communication partner with whom the current user A is or can be connected, with the result that the current user A is displayed to different communication partners with different ComBOT™ images.

Furthermore, the communication window 50 can have a telephone selection element 54 to establish a telephone connection, and a file selection element to attach a flagged message or attach a file, so that further data, which can be sound, image or video data for example, can supplement the text message.

A further function which the client program of the present invention makes available is that files can be dragged onto the ComBOT™ 13 on the background surface 10 of the screen by drag-and-drop. The file symbol is selected and, with mouse button depressed, guided over the ComBOT™ 13 and the mouse button released there. The file allocated to the file symbol is then sent immediately to the communication partner allocated to the ComBOT™ 13.

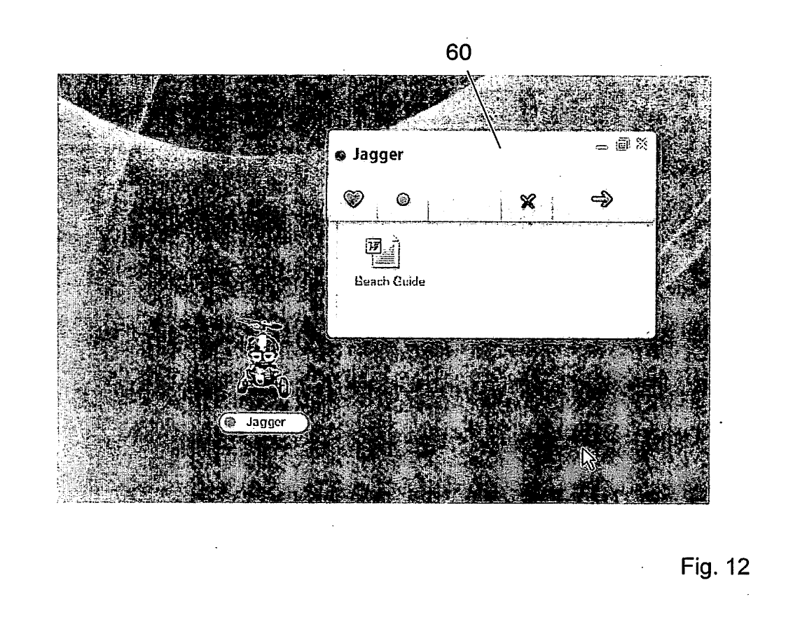

The result of “dropping” the file symbol onto the ComBOT™ 13 of the communication partner is that, as shown in FIG. 12, a second communication window 60 is automatically opened. However, the second communication window 60 is smaller but likewise allows a text input which can be sent to the communication partner allocated to the ComBOT™ 13 by pressing the Enter key. In this embodiment, the second communication window has no first subwindow to display the previously written texts. In particular, after inputting a text and then pressing the “Enter” key, the second communication window can automatically be closed and the file and the input text sent to the communication partner.

After the file symbol is dropped onto the ComBOT™ 13, the second communication window 60 is opened and a small presentation, e.g., a preview of an image or a video sequence preview, is already displayed in the second communication window, so that the current user can ensure that he has “dropped” onto the ComBOT™ 13 the correct file which is to be sent to the allocated communication partner.

Generally speaking, the display of communication windows can be linked to the different functions which are called in the client program. In the client program, the size and the functions available therein of the communication window can be different, depending on the type of function called. This is advantageous because, when sending a file, often only a one-off very short text communication from the current user is needed to comment when required on the file. On the other hand, if the current user consciously chooses an IM connection, he usually has it in mind to carry out a lengthier communication with the allocated communication partner.

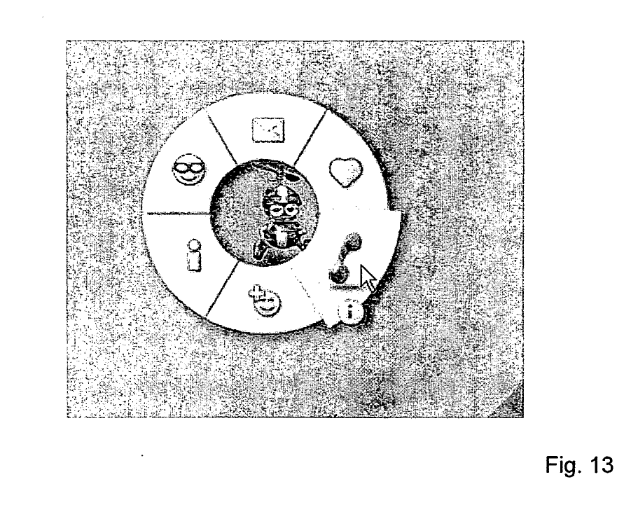

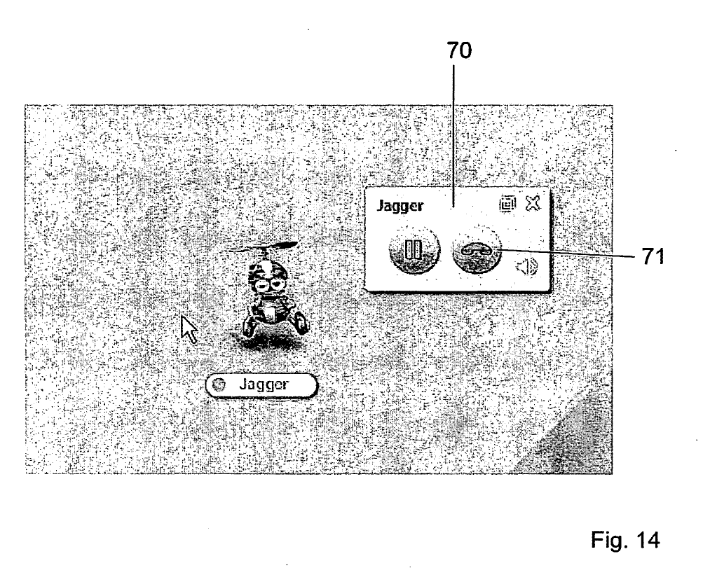

The display of a communication window can furthermore also be made dependent on what type of communication the current user selects. Thus for example if the corresponding segment 15 of the ComBOT™ menu 14 is selected to establish a telephone connection (see FIG. 13), a third communication window 70 (see FIG. 14) can simultaneously be opened which is merely provided with operating elements to change settings relating to the called program function. As the telephone connection represents the main communication level, no space for making entries is required here, with the result that a communication window provided merely with the operating elements 71 is sufficient. On the other hand, when establishing a communication connection such as an IM communication as described above, a large first communication window is displayed.

Furthermore, the size of the communication window and the functions that can be selected therein can be executed depending on the operating function with which the user selects or starts the application. The operating function can be specified, for example, with a mouse click, with a drag & drop, or with a mouse movement over a specific area of the display interface such as a mouseover. In this way, the user can determine the size and functionality of the communication window by choosing how the desired function of the client program is called. Thus the same function can be called in different ways, with the result that in addition to executing the corresponding function a communication window dependent on the type of call is displayed.

Alternatively or in addition, the size of the communication window and the functions that can be selected therein can be determined depending on whether a specific function of the client program is selected or started by the current user of the corresponding terminal or whether for example the communication partner connected to the current user starts a specific function of the client program at the current user via the communication connection. Thus a communication window with a specific size and with specific functions can be displayed when a call is made by the communication partner, the latter writes an e-mail and similar. The communication window opened in these cases can differ in size and functionality from those which are opened by actions of the user himself.

Furthermore, each call of a function of the client program via the ComBOT™ 13 can preferably lead to the display of a corresponding communication window, matched thereto, further specific subfunctions being selectably displayable by corresponding selection elements to execute the function. In particular, the communication windows can have subwindows for inputting and transmitting text messages by pressing a text message selection element.

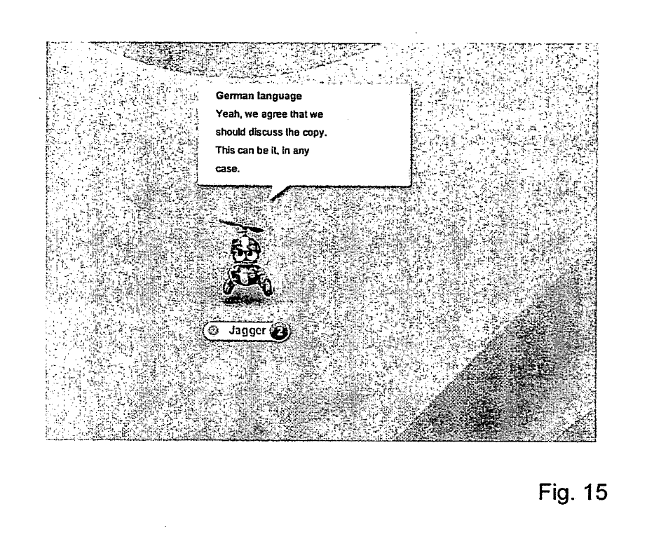

Furthermore, it is possible that when the communication partner sends a message, the message is displayed as a speech bubble (see FIG. 15) to the ComBOT™ symbol allocated to the communication partner, and furthermore the ComBOT™ symbol of the communication partner who has sent the text message executes a specific animation to attract the attention of the communication partner. A click on the speech bubble can then open a communication window which makes possible a further IM connection with the communication partner.

Additionally, there can be located in the communication window a selection element to call the animotion selection menu which makes possible the selection of an animation for its own ComBOT™ symbol. Following selection, the selected ComBOT™ image is transmitted to the communication partner, with the result that the ComBOT™ symbol allocated to the current user executes the animation in order to communicate a specific emotion or mood non-verbally.

As FIGS. 16a-d illustrate in more detail, the selection menu 14 (ComBOT™ menu) can be progressively expanded around the ComBOT™ 13 and can be spatially securely allocated to it. In a preferred embodiment of the present invention, it is only when the user clicks on the ComBOT™ 13 or there is a mouseover does the ComBOT™ menu 14 appear, very small at first, then begin to expand almost “out of nothing” as shown in FIG. 16a. The menu 14 expands spirally or spiral-shaped to form a ring enclosing the ComBOT™ and the individual segments become increasingly more visible, as illustrated in FIGS. 16b and 16c. The spiral movement is realized by a corresponding graphic animation and shown here in FIG. 16b by a symbolic arrow. The menu 14 itself has a semi-transparent appearance at least during the development phase, with the result that the user can still easily recognize the ComBOT™. The spiral movement is concluded in the position in which the menu 14 has reached its predefinable final size and the segments are located in the predefinable normal positions, with the result that the menu 14 completely encloses the ComBOT™, as shown in FIG. 16d.

While the invention has been particularly shown and described with reference to preferred embodiments thereof, it will be understood by those skilled in the art that various changes in form and details may be made therein without departing from the spirit and scope of the invention.

What is claimed is:

1. A device for providing a selection menu allocated to a displayed symbol, the device comprising:
a graphic display unit comprising a display interface configured to display a pointer;
an input device operable to control the pointer; and
a control unit operable to drive the display unit so as to display a plurality of selection elements of the selection menu on the display interface when a predefined function is activated so that an image form of the displayed symbol can be selected via the plurality of selection elements, the control unit being further operable to drive the display unit so as to animate a first selection element of the plurality of selection elements when the pointer is positioned over the first selection element.

2. The device as recited in claim 1, wherein the control unit is operable to drive the display unit so as to highlight a second selection element of the plurality of selection elements when the pointer is positioned over the second selection element, the highlighting comprising displaying the second selection element as at least one of enlarged, displaced, and in a different color with respect to the selection menu.

3. The device as recited in claim 1, wherein the plurality of selection elements are arranged in a grid.

4. The device as recited in claim 2, wherein the grid is incorporated into the selection menu.

5. The device as recited in claim 1, wherein the control unit is further operable to drive the display unit such that the selection menu is displayed with a size-adjusting element for setting a size of the displayed plurality of selection elements.

6. The device as recited in claim 1, wherein the control unit is further operable to drive the display unit such that the selection menu is displayed with a text-display selection element for toggling a display of texts for the selection elements.

7. The device as recited in claim 6, wherein the texts comprise descriptions for the plurality of selection elements.

8. The device as recited in claim 1, wherein the control unit is operable to drive the display unit such that the plurality of selection elements are displayed with respective header elements so as to enable, by activating one of the respective header elements, a selection from the plurality of selection elements displayed in the selection menu according to predefinable criteria.

9. The device as recited in claim 1, wherein the control unit is operable to drive the display unit such that the plurality of selection elements are allocated to a currently displayed symbol, and provide a respective animation in conjunction with the currently displayed symbol.

10. The device as recited in claim 1, wherein the control unit is operable to drive the display unit such that the plurality of selection elements corresponds to alternative symbols of a currently displayed symbol.

11. The device as recited in claim 1, wherein when one of the plurality of selection elements is selected, the control unit is operable to inform a further device connected to the device of the selection.

12. A method for providing a selection menu allocated to a displayed symbol, the method comprising the steps of:
displaying, upon activating of a predefined function, the selection menu on a display interface of a display unit, the selection menu having a plurality of selection elements usable to select an image form of the displayed symbol; and
animating a first selection element of the plurality of selection elements when a pointer of an input device is positioned over the first selection element.

13. The method as recited in claim 12, further comprising the step of:
highlighting a second selection element of the plurality of selection elements when the input device is positioned over the second selection element, the highlighting comprising at least one of displaying the second selection element; laterally displaying the second selection element on the display interface, displaying the second selection element in a different color, and enlarging the second selection element on the display interface in relation to the selection menu.

14. The method as recited in claim 12, further comprising the step of:
displaying the plurality of selection elements with a size-adjusting element,

15. The method as recited in claim 14, further comprising the step of:
setting, using the size-adjusting element, a size of the plurality of selection elements displayed in a grid within the selection menu.

16. The method as recited in claim 12, further comprising the step of:
displaying the plurality of selection elements with a text-display selection element for switching on/off a display of a text to at least one of the plurality of selection elements.

17. The method as recited in claim 12, further comprising the step of:
displaying the plurality of selection elements with a plurality of header elements for, by activating one of the plurality of header elements, making a choice from the plurality of selection elements displayed in the selection menu.

18. The method as recited in claim 12, further comprising the steps of:
allocating the plurality of selection elements to a currently displayed symbol; and
providing an animation in conjunction with the currently displayed symbol.

19. The method as recited in claim 12, wherein the plurality of selection elements correspond to alternative symbols of the currently displayed symbol.

20. The method as recited in claim 12, further comprising the steps of:
selecting one of the plurality of selection elements; and
informing a connected device of the selection.
